(19) United States
(12) Patent Application Publication
(10) Pub. No.: US 2005/0271352 A1
(43) Pub. Date: Dec. 8, 2005

(54) Apparatus and program for image classification

(76) Inventor: Kouji Yokouchi, Kanagawa-ken (JP)

Correspondence Address: BIRCH STEWART KOLASCH & BIRCH, PO BOX 747, FALLS CHURCH, VA, 22040-0747, US

(21) Appl. No.: 10/669,471

(22) Filed: Sep. 25, 2003

(30) Foreign Application Priority Data
Sep. 26, 2002 (JP) 281672/2002

(51) Int. Cl. H04N 9/74

(52) U.S. Cl. 386/4

(57) ABSTRACT

Image data sets can be classified more freely according to accompanying information added thereto. A user sends the image data sets to an image storage server. Tag information reading means of image organizing means reads tag information added to the image data sets. Information item specification means specifies information items and priority thereof to be used for image classification, from information items described in the tag information. Image classification means classifies the image data sets into groups having a hierarchical structure according to the specified information items and the priority thereof, and generates classification information. The classification information is stored in a storage database, together with the image data sets and thumbnail image data sets thereof.

### BACKGROUND OF THE INVENTION

1. Field of the Invention

The present invention relates to an apparatus for classifying image data sets obtained by a digital camera or the like, and to a program for causing a computer to execute classification processing.

2. Description of the Related Art

Conventional prints generated from silver salt photographic films have been used in various manners. For example, such prints are used for checking how the prints (photographs) look, for communication with friends by viewing the prints, for sending additional prints to friends, for display of enlargements thereof, and for generation of photograph albums.

Meanwhile, images are often managed in the form of image data sets, and the image data sets are obtained by reading the images recorded on a film or prints, or by a digital camera. When the image data sets obtained in the above manner are managed, a user who manages the image data sets generates folders corresponding to the date of photography or events, and classifies the image data sets manually into the folders while confirming the images.

However, classification of image data sets becomes more troublesome as the number of the image data sets grows. Especially, in the case of a digital camera, a large number of imaged data sets are often obtained, since no cost is necessary for films. Therefore, various methods have been proposed for automatically classifying image data sets. For example, image data sets are classified according to recording media wherein the image data sets were recorded, or according to films from which the image data sets were obtained. Alternatively, image data sets are classified in hierarchal folders corresponding to years, months, and dates. Furthermore, in another method, image data sets are classified according to the date of photography, with reference to information representing time and date of photography added to the image data sets (Japanese Unexamined Patent Publications No. 5(1993)-165935 and 2001-228528). In still another method, image data sets are classified first according to date of photography, and classified further according to similarity between images (Japanese Unexamined Patent Publication No. 2000-112997). In yet another method, image data sets obtained by a digital camera are classified according to orientation of the digital camera at the time of photography or according to images having the same time information (U.S. Pat. No. 5,576,759, or according to predetermined events related to the date of photography (Japanese Unexamined Patent Publication No. 2002-096145).

By using such a method of automatic image data classification, a user can efficiently classify image data sets.

Meanwhile, image data sets dealt with by users have been diversified for private use or for study, since image data sets are easy to obtain. Consequently, classification according to items specific to each field or according to more detailed items is often desired. For example, in the case of image data sets representing images of fish, the items to classify subjects of the images refer to sea fish/fresh-water fish, families they belong to, and adult fish/immature fish. In the case of image data sets related to recipes, the items refer to cooking time, cost, main ingredients, and calories, for example. However, according to the above-described methods that have been proposed, the items for classification have been predetermined and limited to general items. Therefore, the degree of freedom in classification is low.

### SUMMARY OF THE INVENTION

The present invention has been conceived based on consideration of the above circumstances. An object of the present invention is therefore to provide an image classification apparatus enabling classification of image data sets with a higher degree of freedom, and a program that causes a computer to execute classification procedures.

An image classification apparatus of the present invention is an apparatus for classifying image data sets added with accompanying information including a plurality of information items, and the image classification apparatus comprises:
accompanying information obtaining means for obtaining the accompanying information from the image data sets;
information item specification means for specifying a portion of or all of the information items of the accompanying information to be used for image classification, and for specifying priority among the specified information items; and
image classification means for classifying the image data sets into groups having a hierarchical structure of the specified information items according to the specified priority.

The accompanying information refers to information added to the image data sets for representing a characteristic, a nature, and a state of the image data sets, for example. More specifically, the accompanying information represents time and date of photography, a photography condition, a photography location, a size of an image, the type of a subject, the name of the subject, the number of objects as the subject, an event, and a comment, for example.

The information items refer to item names regarding the accompanying information. The information items include not only the items in the accompanying information but also items of more detailed information extracted from the accompanying information. For example, if one of the items in the accompanying information represents the time and date of photography, the information items can be “photography year”, “photography month”, and “photography date”.

The photography condition refers to various settings of an imaging apparatus and weather at the time of photography. For example, the photography condition refers to shutter speed such as 1/125 second, an aperture state such as fll, and “cloudy” as the weather.

The size of an image refers to an aspect ratio or the number of pixels of the image represented by each of the image data sets, for example. The size can be expressed as “640×400”, for example.

The type of subject refers to people, mountain, sea, and building, for example.

The name of the subject refers to a person's name such as “Mr. Yamada” and “Ms. Tanaka” in the case of the person being the subject. In the case where the subject is a mountain or sea, the name refers to “Mt. Takao” and “Miura Beach”, for example.

The number of objects as the subject refers to the number of people in the image as the subject thereof, in the case that the type of subject is people.

The comment refers to a word or a sentence expressed by a user such as a photographer, regarding the image. For example, “A walk with my dog Shiro”, and “Haruo's first experience in a pool” can be used as the comment.

The accompanying information can be described as tag information of the image data sets.

In the case where the image data sets have been obtained by a digital camera, the accompanying information is added to the image data sets by the digital camera. In the case where the image data sets have been obtained by reading images recorded on a film or the like with reading means such as a scanner, the accompanying information is added to the image data sets by the reading means. The accompanying information may be added to the image data sets by the digital camera or by the reading means either in an automatic manner or through a manual operation by the user.

Classifying the image data sets into groups having a hierarchical structure of the specified information items according to the specified priority refers to firstly classifying the image data sets according to the top-priority information item so that the image data sets are classified into groups at the top of the hierarchical structure, and by classifying the image data sets in each of the groups in the top hierarchical structure according to the information item having the second-highest priority so that the groups classified in this manner are positioned second highest in the hierarchical structure. In this manner, the classification is repeated according to the priority, and the image data sets are classified into the groups having the hierarchical structure.

In an image classification apparatus of the present invention, the accompanying information may include classification condition information representing a set of the information items to be used for image classification so that the information item specification means can specify the information items to be used for image classification according to the classification condition information.

In an image classification apparatus of the present invention, the accompanying information may include classification condition information representing a combination of the information items to be used for image classification and the priority thereof so that the information item specification means can specify the information items to be used for image classification and the priority thereof, according to the classification condition information.

The classification condition information represents the set of the information items to be used for image classification, and the classification condition information is described by a creator or user of the image data sets or by a photography apparatus, for example. According to the type or category of the image data sets, the classification condition information represents the set of the information items or the combination of the information items and the priority thereof. The classification condition information represents the combination of the information items and the priority as “1. photography location, 2. photography year, 3. photography month, 4. photography date”, for example.

In the image classification apparatus of the present invention, the information item specification means may specify the information items and the priority thereof according to a manual operation by a user or in an automatic manner according to the classification condition information included in the accompanying information. Alternatively, the user may select either the manual operation or the automatic manner. In addition, only the information items to be used for image classification may be determined according to the classification condition information so that the user can specify the priority thereof. Alternatively, the user may specify the information items and the priority thereof by modifying the combination of the information items and the priority represented by the classification condition information. Furthermore, the classification condition information may represent a plurality of combinations of the information items and the priority thereof so that the user can select one of the combinations.

The means of the image classification apparatus may be provided as procedures of a program for causing a computer to execute the functions of the means.

The image data sets may be still image data sets or video data sets representing moving images. In addition, the image data sets may include audio information representing a sound.

According to the image classification apparatus having the configuration described above, the accompanying information including the information items is obtained from the image data sets, and the information items to be used for image classification are specified among the information items. The priority of the specified information items is also specified so that the image data sets are classified into the groups having the hierarchical structure of the specified information items according to the specified priority. Therefore, the image data sets can be classified with a high degree of freedom.

If the accompanying information includes the classification condition information representing the set of the information items to be used for image classification and the information items are specified for image classification according to the classification condition information, the image data sets can be classified by the specified information items without specification of the information items and the priority thereof by the user.

If the accompanying information includes the classification condition information representing the combination of the information items and the priority thereof to be used for image classification, and the information items and the priority thereof are specified for image classification according to the classification condition information, the image data sets can be classified by the specified information items and the specified priority thereof, without specification of the information items and the priority thereof by the user.

### BRIEF DESCRIPTION OF THE DRAWINGS

FIG. 1 is a block diagram showing the configuration of an image storage system as an image classification apparatus of a first embodiment of the present invention;

FIG. 2 shows diagrams for explaining classification of image data sets;

FIG. 3 shows a result of the classification of the image data sets;

FIG. 4 shows another result of the classification of the image data sets;

FIG. 5 is a flow chart showing procedures carried out in the first embodiment;

FIG. 6 shows a result of the classification of the image data sets displayed on a personal computer; and

FIG. 7 is a flow chart showing procedures carried out in a second embodiment of the present invention.

### DESCRIPTION OF THE PREFERRED EMBODIMENTS

Hereinafter, embodiments of the present invention will be explained with reference to the accompanying drawings.

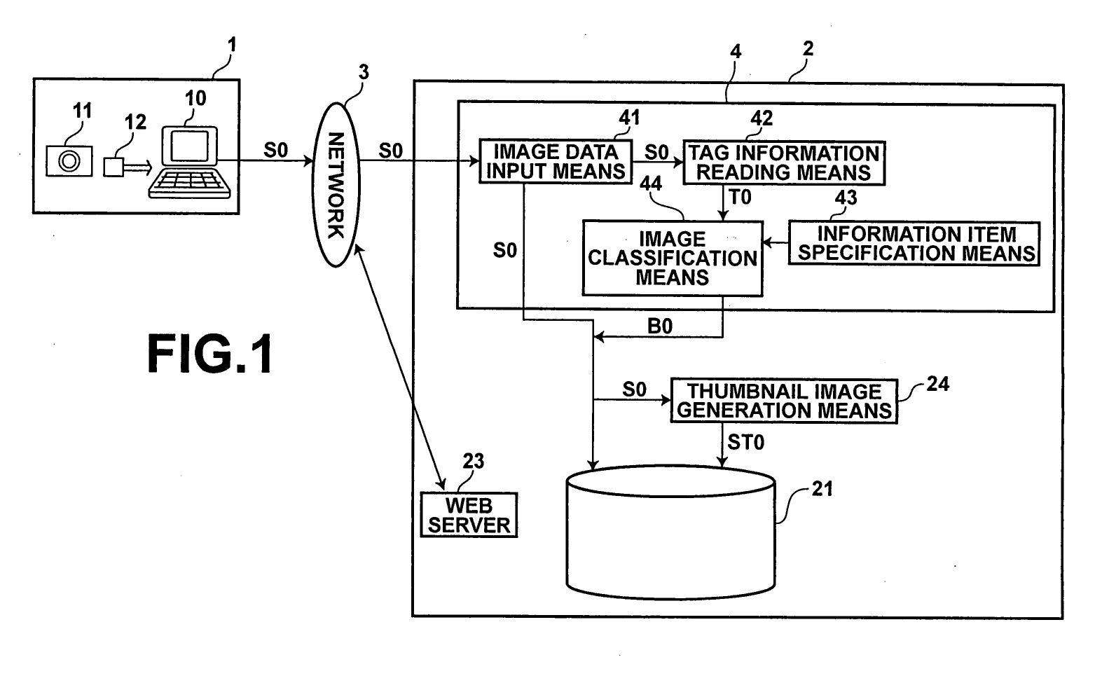

FIG. 1 is a block diagram showing the configuration of an image storage system as an image classification apparatus of a first embodiment of the present invention. The image storage system shown in FIG. 1 exchanges data between a personal computer 10 owned by a user 1 and an image storage server 2 having the image classification apparatus of the present invention. The image storage server 2 is connected to the personal computer 10 of the user 1 via a network 3.

The user 1 obtains image data sets S0 by using a digital camera 11 of his/her own, and records the image data sets S0 in a memory card 12. The user 1 reads the image data sets S0 from the memory card 12 by using the personal computer 10, and stores the image data sets S0 in a hard disc of the personal computer 10. When the user requests classification of the image data sets S0, the user sends the image data sets S0 to the image storage server 2 via the network 3.

The digital camera 11 records information on time and date of photography (hereinafter referred to as the photography date information), photography location information representing a place of photography, and subject information representing the type of a subject, in tag information T0 of the image data sets S0 at the times of photography thereof.

The personal computer 10 has been installed with viewer software for viewing the image data sets S0, and a general-purpose Web browser. The user 1 uses the viewer software for viewing the image data sets S0 obtained by photography with the digital camera 11. The user 1 can also access the image storage server 2 by using the Web browser and can request classification of the image data sets S0 from the image storage server 2. When the user 1 requests classification of the image data sets S0 from the image storage server 2, the image data sets S0 are sent to the image storage server 2 via the network 3. At this time, user information for identifying the user 1 is also sent to the image storage server 2. The user information may be described in the tag information T0 of the image data sets S0.

The image storage server 2 comprises a storage database 21 such as a hard disc or a RAID, an information database 22 (not shown), image organizing means 4 according to the first embodiment, a Web server 23, and thumbnail image generation means 24. The storage database 21 stores the image data sets S0, thumbnail image data sets ST0, and classification information B0 representing a result of classification of the image data sets S0, as will be explained later. The information database 22 stores various kinds of information such as the user information. The Web server 23 enables the user 1 to view the data sets and the information stored in the storage database 21 via the network 3. The thumbnail image generation means 24 generates the thumbnail image data sets ST0 representing thumbnail images from images represented by the image data sets S0.

In the first embodiment, the storage database 21 stores the image data sets S0, the thumbnail image data sets ST0, and the classification information B0. The image storage server 2 may carry out procedures of the means thereof by using software having the procedures, instead of having the means themselves.

The image organizing means 4 comprises image data input means 41, tag information reading means 42, information item specification means 43, and image classification means 44. The image data input means 41 receives an input of the image data sets S0. The tag information reading means 42 reads the tag information T0 added to the image datasets S0. The information item specification means 43 specifies information items to be used for classification of the image data sets S0 from items in the tag information T0, and specifies priority among the specified information items. The image classification means 44 classifies the image data sets S0 into groups having a hierarchical structure of the specified information items according to the specified priority, and generates the classification information B0 representing the result of classification.

The image data input means 41 comprises a communication interface for receiving the image data sets S0 sent from the personal computer 10.

The image organizing means 4 selects the information items to be used for image classification from the information items described in the tag information T0, and specifies the priority thereof. The image organizing means 4 also classifies the image data sets S0 into the groups having the hierarchical structure of the specified information items, according to the priority that has been specified.

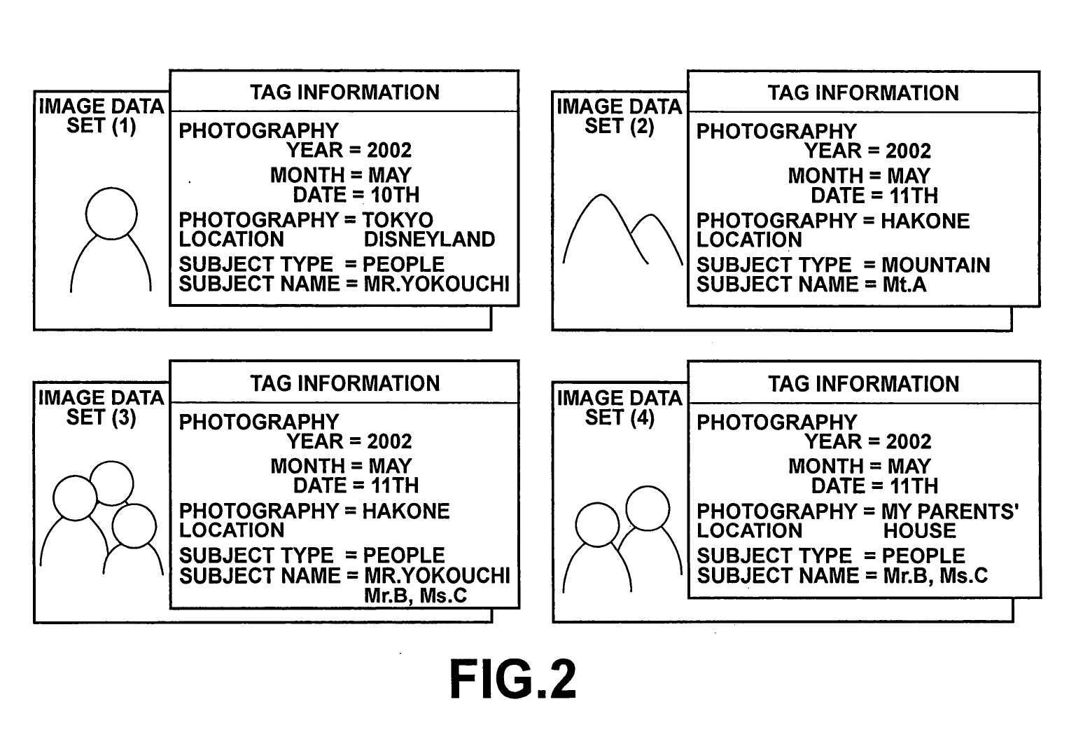

FIG. 2 shows diagrams for explaining classification of the image data sets S0. The tag information T0 of each of the image data sets S0 has the information items comprising the date/month/year of photography, the photography location, the subject type, and the name of the subject. These information items may be described automatically by the digital camera 11 or by a manual operation carried out by the user 1. In addition to the predetermined information items, the user 1 can arbitrarily generate an information item so that the user 1 can describe specific information in the item. For example, if the image data sets S0 represent images of cooking, the user 1 may generate an item “ingredients” as one of the information items in the tag information T0 so that the user 1 can describe “beef” as the content of the newly generated information item, for example.

Therefore, the image classification means 44 classifies the image data sets S0 into the groups having the hierarchical structure of the specified information items, according to the priority specified by the information item specification means 43. For example, in the case where the information items and the priority thereof are specified as “1. photography location, 2. photography year, 3. photography month, and 4. photography date”, the image data sets S0 are first classified according to the photography location. Thereafter, the image data sets S0 are further classified according to the photography year, and then by the photography month followed by the photography date. More specifically, folders having the hierarchical structure of “photography location”, “photography year”, “photography month” and “photography date” are generated, and the image data sets S0 are stored in the folders at the lowest level of the hierarchical structure.

The image classification means 44 classifies the image data sets S0 in the above manner, and generates the classification information B0 representing the classification result. By referring to the classification information B0, the image data sets S0 can be classified according to the specified information items.

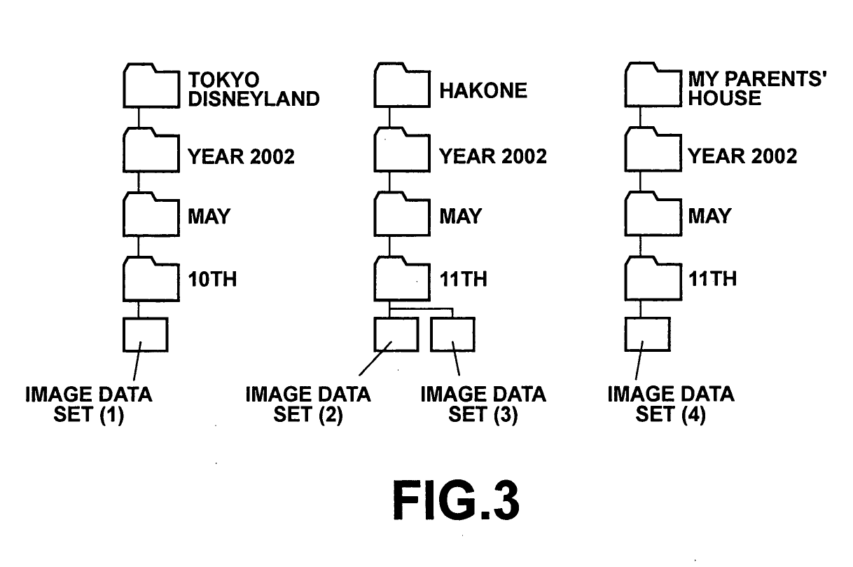

FIG. 3 shows the result of classification. FIG. 3 shows the case where the information items and the priority thereof are “1. photography location, 2. photography year, 3. photography month, and 4. photography date”. As shown in FIG. 3, a folder “year 2002” is generated under a folder “Disneyland”. Under the folder “Year 2002” is generated a folder “May”, and a folder “10^{th}” is generated under the “May” folder. Folders having the hierarchical structures such as “Hakone”—“Year 2002”—“May”—“11^{th}”, and “My Parents' House”—“Year 2002”—“May”—“11^{th}” are also generated.

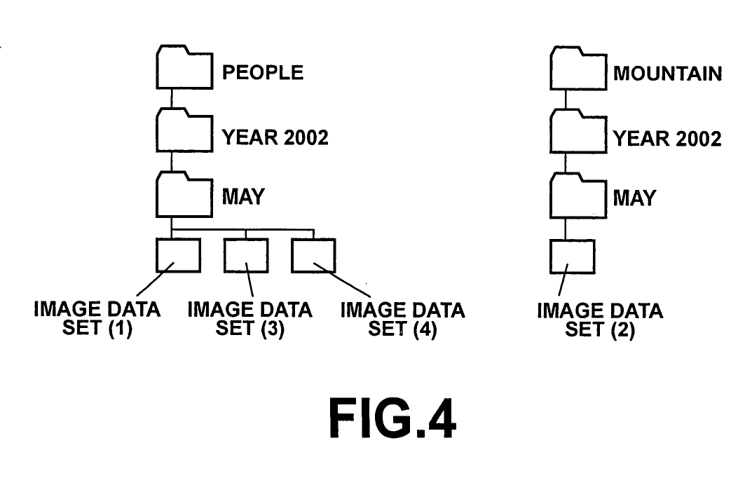

FIG. 4 shows another result of the classification in the case where the information items and the priority thereof are “1. subject type, 2. photography year, and 3. photography month”. As shown in FIG. 4, a folder “People” is generated, and a folder “Year 2002” is generated under the “People” folder. Under the “Year 2002” folder is generated a folder “May”. In addition, folders having a hierarchical structure such as “Mountain”—“Year 2002”—“May” are also generated.

In the case where the classification result is displayed, the image data sets S0 are shown as the thumbnail image data sets ST0 with reference to the classification information B0.

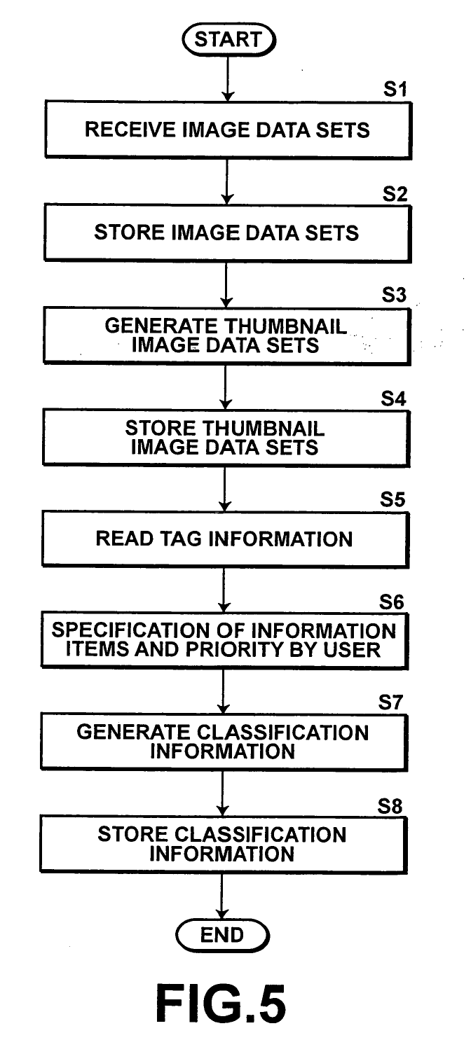

The operation of the first embodiment will be explained next. FIG. 5 is a flow chart showing procedures carried out in the first embodiment.

First, the image data sets S0 obtained by the user 1 with the digital camera 11 are sent from the personal computer 10 of the user 1 to the image storage server 2 via the network 3, and the image storage server 2 receives the image data sets S0 by using the image data input means 41 (Step S1). The image data sets S0 are stored in the storage database 21 (Step S2), and the thumbnail image generation means 24 generates the thumbnail image data sets ST0 from the image data sets S0 (Step S3). The thumbnail image data sets ST0 are also stored in the storage database 21 (Step S4).

The tag information reading means 42 reads the tag information T0 added to the image data sets S0 (Step S5), and the tag information is input to the image classification means 44. The user 1 specifies the information items and the priority thereof to be used for image classification, by using the information item specification means 43 (Step S6). The image classification means 44 classifies the image data sets S0 into the groups having the hierarchical structure of the specified information items, according to the specified priority, and generates the classification information B0 (Step S7). The classification information B0 is stored in the information database 21 (Step S8) to end the process.

The order of the procedures at Step S2, at Steps S3 and S4, and at Steps S5 to S8 is arbitrary, and the procedures may be carried out in parallel.

The user 1 accesses the Web server 23 from the personal computer 10, and inputs an instruction to display the classification result of the image data sets S0 he/she sent. The image data sets S0 are then displayed on the personal computer 10 with reference to the classification information B0.

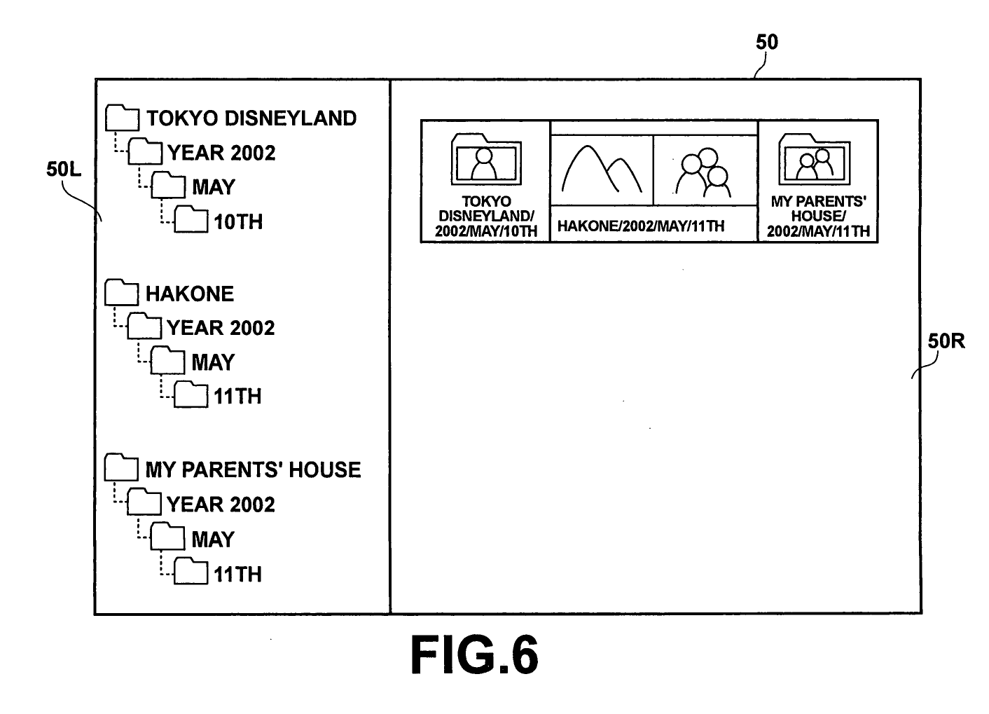

FIG. 6 shows the classification result of the image data sets S0 displayed on the personal computer 10. As shown in FIG. 6, the classification result is shown as a classification result display screen 50 on the personal computer 10. In a left frame SOL on the left side of the screen 50 is shown the folder structure of the classification result, and in a right frame SOR on the right side are shown the thumbnail images as representatives of the images classified in the respective folders. The user 1 can display the thumbnail images of the image data sets S0 classified in each of the folders, by clicking a corresponding one of the folders in the right frame 50R of the screen 50. In FIG. 6, the thumbnail image data sets ST0 of the image data sets S0 classified in the folder structure “Hakone”—“Year 2002”—“May”—“11^{th}” are shown.

Furthermore, the name of each of the folders is also displayed as a title thereof.

In the case where a portion of the image data sets S0 is misclassified due to an error in description in the tag information T0 or the like, the classification result needs to be changed. In this case, the user 1 can change the folder in which each of the misclassified image data sets S0 is to be classified, by changing the folder in which the corresponding thumbnail image data set ST0 of the image data set S0 is currently classified, with use of the personal computer 10. More specifically, the corresponding thumbnail image is dragged and dropped to a desired one of the folders. Consequently, the corresponding image data set S0 can also be moved to the folder. The change is sent to the Web server 23 from the personal computer 10, and the Web server 23 corrects the classification information B0 according to the change made by the user 1.

The user 1 can display the classification result display screen 50 shown in FIG. 6, by accessing the Web server 23 from the personal computer 10. However, in some cases, the user 1 may wish to display the classification result by accessing the Web server 23 from a mobile terminal such as PDA or a mobile phone. Since a mobile terminal has a small display screen, it is preferable for the classification result to be displayed on the mobile terminal as a classification result display screen for the mobile terminal. For example, the representative images may not be displayed in the screen for the mobile terminal, or only the folder structure shown in the left frame SOL may be displayed.

As has been described above, according to the first embodiment, the information items to be used for classification of the image data sets S0 are specified from the tag information T0 added to the image data sets S0, and the priority thereof is also specified. The image data sets S0 are then classified according to the priority into the groups having the hierarchical structure of the information items that have been specified. Therefore, the image data sets S0 can be classified with a high degree of freedom.

In the first embodiment described above, the image data sets S0, the thumbnail image data sets ST0, and the classification information B0 are stored in the storage database 21. However, the image data sets S0, the thumbnail image data sets ST0, and the classification information B0 may be stored in another storage database connected to the image storage server 2 via a network. Alternatively, the image data sets S0, the thumbnail image data sets ST0, and the classification information B0 may be stored separately in respective databases therefor.

An image storage system as an image classification apparatus of a second embodiment of the present invention will be explained next. In the first embodiment, the information items and the priority thereof to be used for image data classification are specified according to a manual operation by the user 1. In the second embodiment, the information items and the priority thereof are specified automatically according to classification condition information described in the tag information T0 added to the image data sets S0. The classification condition information refers to information representing the information items to be used for image classification or a combination of the information items and the priority thereof, according to the type or category of the image data sets S0. The classification condition information may be described by a person who generated the image data sets S0 (the user 1) or automatically, by an imaging apparatus (the digital camera 11). In this embodiment, the classification condition information represents the combination of the information items and the priority thereof.

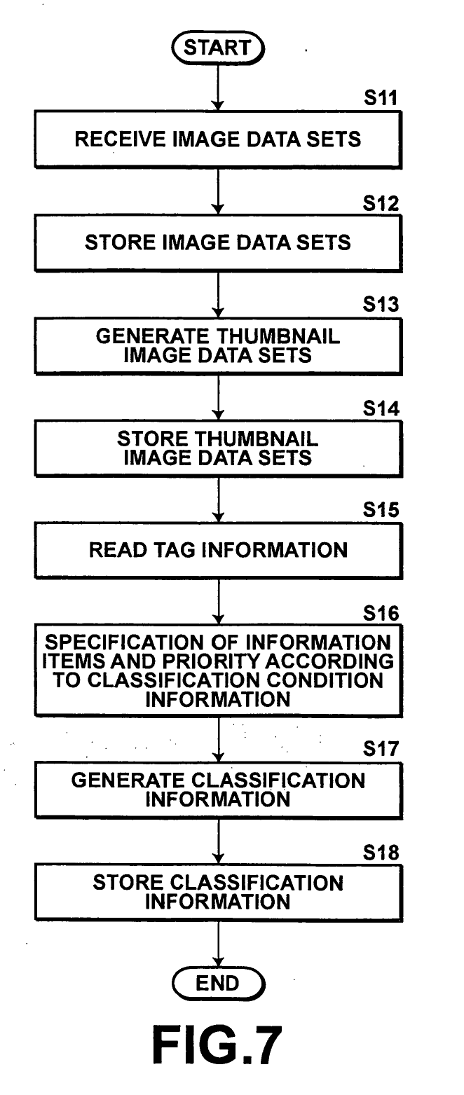

The operation of the second embodiment will be explained next. FIG. 7 is a flow chart showing procedures carried out in the second embodiment.

The image data sets S0 obtained by the user 1 with the digital camera 11 are sent from the personal computer 10 of the user 1 to the image storage server 2 via the network 3, and the image storage server 2 receives the image data sets S0 by using the image data input means 41 (Step S11). The image data sets S0 are stored in the storage database 21 (Step S12), and the thumbnail image generation means 24 generates the thumbnail image data sets ST0 from the image data sets S0 (Step S13). The thumbnail image data sets ST0 are also stored in the storage database 21 (Step S14).

The tag information reading means 42 reads the tag information T0 added to the image data sets S0 (Step S15). The tag information T0 is input to the information item specification means 43 and the image classification means 44. The information item specification means 43 specifies the information items and the priority thereof to be used for image classification of the image data sets S0, according to the classification condition information described in the tag information T0 (Step S16). The image classification means 44 classifies the image data sets S0 into the groups having the hierarchical structure of the specified information items, according to the information items and the priority thereof. The image classification means then generates the classification information B0 (Step S17), and the classification information B0 is stored in the storage database 21 (Step S18) to end the process.

As has been described above, according to the second embodiment, the information items and the priority thereof are specified according to the classification condition information described in the tag information T0 of the image data sets S0, and the image data sets S0 are classified according to the information items and the priority thereof. Therefore, the image data sets S0 can be classified appropriately although the user 1 does not need to specify the information items and the priority thereof.

For example, assume the case where a father, a mother and their son use the digital camera 11 as the user 1, and photograph images of different categories. The digital camera 11 is assumed to have a function of describing the classification condition information whose content varies from the three users in the tag information T0. Although the image data sets S0 obtained by photography with the digital camera 11 are in the categories that are different between the three users, each of the users can classify the image data sets S0 of his/her own after selecting his/her image data sets. In this case, without specification by the user 1 of the information items and the priority thereof to be used for image classification, the image data sets S0 can be classified as desired by the user 1, according to the information items and the priority thereof specified by the classification condition information described in the tag information T0 of the image data sets S0.

In the case where the user 1 wishes to see a classification result of the image data sets S0 whose content is not known well by the user 1, the image data sets S0 can be classified to show the classification result to the user 1 if the classification condition information is included in the tag information added to the image data sets S0.

The combination of the information items and the priority thereof may not necessarily be limited to one pattern. A plurality of combinations may be prepared so the user 1 can specify one of the combinations to be used for classification. For example, assume the case where the image data sets S0 represent images of used cars for a sales catalog, and the user 1 decides which car to buy while viewing the images. If the tag information T0 of the image data sets S0 has the information items “make”, “model name”, “model year”, “type”, “engine type”, “engine displacement”, “horsepower”, “weight”, “the number of cars produced”, “fuel consumption”, “price”, “color”, and “effective or ineffective car inspection”, and if the combinations are (1) 1. make 2. model name 3. color for emphasizing design, (2) 1. price 2. fuel consumption 3. effective or ineffective car inspection for emphasizing economics, and (3) 1. type 2. engine displacement 3. horsepower for emphasizing comfort, the user 1 can select one of the combinations that matches his/her purpose so that the image data sets S0 can be classified appropriately in line with the purpose of the user.

Both the information items and the priority thereof may be specified by the classification condition information, as in the case described above. Alternatively, only the information items may be specified by the classification condition information so that the user 1 can specify the priority thereof. The user 1 can also change the information items and the priority thereof specified by the classification condition information.

In the case where the classification condition information is described in the tag information T0, selection may be made between specification by a manual operation by the user 1 and specification by the classification condition information, regarding the information items and the priority thereof.

In the first and second embodiments described above, the user 1 sends the image data sets S0 from the personal computer 10 thereof to the image storage server 2, and the image storage server 2 classifies the image data sets S0. However, software for classifying the image data sets S0 may be installed in the personal computer 10 so that the user 1 can classify the image data sets S0 by using the personal computer 10.

In this case, the image data sets S0 may be stored in folders in the personal computer 10, as has been described above. Alternatively, only the classification information B0 may be stored in the personal computer 10 so that the classification result can be shown by using the thumbnail image data sets ST0 with reference to the classification information B0.

In the first and second embodiments described above, the user 1 classifies the image data sets S0 obtained by the digital camera 11. However, the image data sets S0 are not necessarily obtained by the digital camera 11. The image data sets S0 may be obtained by reading images recorded on a film or the like. The image data sets S0 may represent not only still images but also moving images, or image data sets including sound information.

In the case where the images recorded on a film or the like are read, the photography date information may be obtained by reading date imprinted on each of the images. Character recognition is carried out on the date, and the photography date information is described in the tag information T0. In addition, the photography location information and the user information can be input at the time of reading.

The images may be read by the user 1 with a scanner of his/her own. Alternatively, the user 1 may request the reading from a laboratory that manages the image storage server 2 so that the reading can be carried out in the laboratory.

In the case where the film is an APS film that enables recording of magnetic information, the photography date information, the photography location information, and the user information may be recorded in a magnetic recording unit thereof at the time of photography. The information is then read from the magnetic recording unit at the time of image reading, and described in the tag information T0.

The various means for performing image classification may be provided as procedures of a computer program. The program may be provided recorded on a computer readable storage medium. A skilled artisan would know that computer readable media are not limited to any specific type of storage device and may refer to any kind of device, including but not limited to: CD's, floppy disks, RAM's, ROM's, hard disks, magnetic tapes and internet downloads, in which computer instructions can be stored and/or transmitted. Transmission of computer code through a network or through wireless transmission means is also within the scope of the present invention. Additionally, computer code/instructions include, but are not limited to: source, object and executable code, and may be in any language including higher level languages, assembly language, and machine language.

1. An image classification apparatus for classifying image data sets added with accompanying information including information items, the image classification apparatus comprising:
accompanying information obtaining means for obtaining the accompanying information from the image data sets;
information item specification means for specifying a portion of or all of the information items of the accompanying information to be used for image classification, and for specifying priority among the specified information items; and
image classification means for classifying the image data sets into groups having a hierarchical structure of the specified information items according to the specified priority.

2. The image classification apparatus according to claim 1, wherein the accompanying information includes classification condition information representing a set of the information items to be used for image classification and
the information item specification means specifies the information items to be used for image classification according to the classification condition information.

3. The image classification apparatus according to claim 2, wherein the accompanying information includes at least one of items comprising time and date of photography, a photography condition, a photography location, a size of an image, the type of a subject, the name of the subject, the number of objects as the subject, an event, and a comment, as the information items thereof.

4. The image classification apparatus according to claim 1, wherein the accompanying information includes classification condition information representing a combination of the information items to be used for image classification and the priority thereof, and
the information item specification means specifies the information items to be used for image classification and the priority thereof, according to the classification condition information.

5. The image classification apparatus according to claim 4, wherein the accompanying information includes at least one of items comprising time and date of photography, a photography condition, a photography location, a size of an image, the type of a subject, the name of the subject, the number of objects as the subject, an event, and a comment, as the information items thereof.

6. The image classification apparatus according to claim 1, wherein the accompanying information includes at least one of items comprising time and date of photography, a photography condition, a photography location, a size of an image, the type of a subject, the name of the subject, the number of objects as the subject, an event, and a comment, as the information items thereof.

7. A program for causing a computer to execute a process of classifying image data sets added with accompanying information including information items, the program comprising the steps of:
obtaining the accompanying information from the image data sets;
specifying a portion of or all of the information items of the accompanying information to be used for image classification and for specifying priority among the specified information items; and
classifying the image data sets into groups having a hierarchical structure of the specified information items according to the specified priority.

8. The program according to claim 7, wherein the accompanying information includes classification condition information representing a set of the information items to be used for image classification, and
the step of specifying the information items is the step of specifying the information items to be used for image classification according to the classification condition information.

9. The program according to claim 8, wherein the accompanying information includes at least one of items comprising time and date of photography, a photography condition, a photography location, a size of an image, the type of a subject, the name of the subject, the number of objects as the subject, an event, and a comment, as the information items thereof.

10. The program according to claim 7, wherein the accompanying information includes classification condition information representing a combination of the information items to be used for image classification and the priority thereof, and
the step of specifying the information items and the priority is the step of specifying the information items to be used for image classification and the priority thereof, according to the classification condition information.

11. The program according to claim 10, wherein the accompanying information includes at least one of items comprising time and date of photography, a photography condition, a photography location, a size of an image, the type of a subject, the name of the subject, the number of objects as the subject, an event, and a comment, as the information items thereof.

12. The program according to claim 7, wherein the accompanying information includes at least one of items comprising time and date of photography, a photography condition, a photography location, a size of an image, the type of a subject, the name of the subject, the number of objects as the subject, an event, and a comment, as the information items thereof.

13. A computer readable recording medium storing thereon a program for causing a computer to execute a process of classifying image data sets added with accompanying information including information items, the program comprising the steps of:
obtaining the accompanying information from the image data sets;
specifying a portion of or all of the information items of the accompanying information to be used for image classification and for specifying priority among the specified information items; and
classifying the image data sets into groups having a hierarchical structure of the specified information items according to the specified priority.

14. The computer readable recording medium according to claim 13, wherein the accompanying information includes classification condition information representing a set of the information items to be used for image classification, and
the step of specifying the information items is the step of specifying the information items to be used for image classification according to the classification condition information.

15. The computer readable recording medium according to claim 14, wherein the accompanying information includes at least one of items comprising time and date of photography, a photography condition, a photography location, a size of an image, the type of a subject, the name of the subject, the number of objects as the subject, an event, and a comment, as the information items thereof.

16. The computer readable recording medium according to claim 13, wherein the accompanying information includes classification condition information representing a combination of the information items to be used for image classification and the priority thereof, and
the step of specifying the information items and the priority is the step of specifying the information items to be used for image classification and the priority thereof, according to the classification condition information.

17. The computer readable recording medium according to claim 16, wherein the accompanying information includes at least one of items comprising time and date of photography, a photography condition, a photography location, a size of an image, the type of a subject, the name of the subject, the number of objects as the subject, an event, and a comment, as the information items thereof.

18. The computer readable recording medium according to claim 13, wherein the accompanying information includes at least one of items comprising time and date of photography, a photography condition, a photography location, a size of an image, the type of a subject, the name of the subject, the number of objects as the subject, an event, and a comment, as the information items thereof.
